(19) United States
(12) Patent Application Publication
(10) Pub. No.: US 2024/0322668 A1
(43) Pub. Date: Sep. 26, 2024

(54) PLANAR TRANSFORMER WITH FLEXIBLE TURN RATIO AND LEAKAGE INDUCTANCE INTEGRATION

(71) Applicant: VIRGINIA TECH INTELLECTUAL PROPERTIES, INC., Blacksburg, VA (US)

(72) Inventors: Liyan Zhu, Christiansburg, VA (US); Qiang Li, Blacksburg, VA (US)

(21) Appl. No.: 18/613,616

(22) Filed: Mar. 22, 2024

Related U.S. Application Data
(60) Provisional application No. 63/491,830, filed on Mar. 23, 2023.

(51) Int. Cl. H02M 1/00; H01F 27/28; H01F 27/38; H02M 3/335

(52) U.S. Cl. CPC H02M 1/0064; H01F 27/2804; H01F 27/38; H02M 3/33584; H01F 2027/2819

(57) ABSTRACT

An example power converter may include a planar transformer including a magnetic core, a primary winding, a first secondary winding interleaved with the primary winding, and a second secondary winding interleaved with the primary winding. The magnetic core may include a first core half, a second core half, multiple auxiliary legs formed by the first core half and the second core half, and multiple core legs formed by the first core half and the second core half. The multiple core legs may include a central core leg, and the primary winding may be wound around the central core leg among the two or more core legs. The planar transformer may be electrically coupled between a primary-side converter stage and a secondary-side converter stage.

### CROSS-REFERENCE TO RELATED APPLICATION

This application claims the benefit of and priority to U.S. Provisional Patent Application No. 63/491,830, filed Mar. 23, 2023, entitled “PLANAR TRANSFORMER WITH FLEXIBLE TURN RATIO AND LEAKAGE INDUCTANCE INTEGRATION,” the contents of which is hereby incorporated herein by reference in its entirety.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC-to-DC conversion, provide an AC-to-AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example power converter according to one or more embodiments of the present disclosure.

FIG. 2 depicts an exploded view of an example planar transformer in the power converter shown in FIG. 1 according to one or more embodiments of the present disclosure.

FIG. 3 depicts an exploded view of the core of the planar transformer shown in FIG. 2 according to one or more embodiments of the present disclosure.

FIG. 4 depicts an exploded view of the planar transformer shown in FIG. 2 with variations in the core according to one or more embodiments of the present disclosure.

FIG. 5 depicts a front view of the planar transformer shown in FIG. 2 according to one or more embodiments of the present disclosure.

FIG. 6 depicts a front view of the planar transformer shown in FIGS. 2, 4, and 5, with a non-interleaving winding structure, according to one or more embodiments of the present disclosure.

FIG. 7 depicts a front view of the planar transformer shown in FIGS. 2, 4, and 5, with a sequentially interleaved winding structure, according to one or more embodiments of the present disclosure.

### DETAILED DESCRIPTION

Power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC-to-DC conversion, provide an AC-to-AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

A range of non-isolated and isolated power converters are known. Examples of non-isolated power converters include buck, boost, buck-boost, and Ćuk power converters. A buck or step-down converter is one example of a non-isolated DC-to-DC power converter that could be relied upon for the conversion of power at a higher DC voltage at a lower current rating to a lower DC voltage at a higher current rating. As a switching converter, a buck converter can provide better power efficiency than linear regulators. The efficiency of buck converters can be relatively high, making buck converters a good choice for DC-to-DC power conversion applications used in computers and computing systems.

Many isolated power converters include isolation transformers and, in some cases, transformer-integrated magnetics. A number of isolated power converter topologies are known, and resonant power converters offer higher efficiency through the reduction of switching losses and other benefits. A range of different integrated magnetic devices, such as integrated transformers, have been used for interfacing the primary and secondary converter stages in isolated power converters.

Wide band gap (WBG) devices, such as Gallium-Nitride (GaN) and Silicon-Carbon (SiC) devices, can operate at higher switching frequencies, greater efficiency, and higher power density than other devices. In many applications, including data center, telecom, energy storage, electric vehicle (EV), wireless power transfer, solid-state transformer, and other applications, WBG devices have been applied to offer a range of benefits. The switching frequency of power converters can be pushed to several hundred kHz or MHz using WBG devices. The use of higher switching frequencies facilitates reduced size and number of passive components, such as magnetics and capacitors, and printed circuit board (PCB) windings can be adopted for planar transformers and inductors.

Some applications for power converters, such as intelligent grids applications, require bi-directional energy transfer. Many onboard chargers (OBCs) of EVs support both grid-to-vehicle energy transfer for in-EV battery charging and vehicle-to-grid energy transfer for intelligent grid functions and power for standalone AC equipment.

In power conversion devices and systems (e.g., power supplies for data centers, OBCs, auxiliary power modules for EVs, etc.) transformers can be the key magnetic components particularly for those that require electric isolation between the input and output. For the more commonly used power conversion topologies such as the dual active bridge or LLC converters, controlling leakage inductance may be necessary for the resonant network or power control purposes. In traditional wire-wound transformers, the leakage inductance is usually large enough to act as the resonant inductor, but the overall transformer may be bulky. Planar transformers based on PCB windings or copper foils can greatly reduce the transformer size. However, the compact size can also mean a tight coupling between the primary and secondary sides, resulting in a leakage inductance that is too small to be used as a resonant inductor. An external resonant inductor may be used to solve this issue, but additional inductors could increase costs and overall magnetic component size.

To eliminate the need for an external inductor in planar transformer-based converters, some power converters rely upon an integrated transformer for both an inductor and the transformer in a single magnetic component. However, these transformers may generate unevenly distributed flux density, with a center leg exhibiting much higher flux density and inducing a higher core loss. Additionally, these transformers may be designed for a unit turn ratio of 1:1. Thus, if a unit turn ratio other than unity is required, the transformer must be split into multiple smaller units and connected in parallel or series to achieve the desired turn ratios. However, splitting the transformer may lower the PCB area utilization since each small unit may need separate connectors on the PCB board. In other conventional transformers, such as matrix transformers that do not include center legs but integrate multiple small units into a single transformer core, these transformers still may require a unit turn ratio. Thus, if a high turn ratio is required, this transformer may need an excessive number of legs, which could create difficulty for fabricating the transformer and increasing transformer size.

Therefore, there remains a continued need for a planar transformer that provides adequate leakage inductance with low losses, particularly for applications that require higher turn ratios other than 1:1. In this context, new transformers, planar transformers, and implementations of such transformers in power converter systems are described herein. An example transformer may include a planar transformer including a magnetic core, a primary winding, a first secondary winding interleaved with the primary winding, and a second secondary winding interleaved with the primary winding. The magnetic core may include a first core half, a second core half, multiple auxiliary legs formed by the first core half and the second core half, and multiple core legs formed by the first core half and the second core half. The multiple core legs may include a central core leg, and the primary winding may be wound around the central core leg among the two or more core legs.

The planar transformers described herein may be used with a DC-DC converter, for example, and may include a first core half, a second core half, and multiple windings. The windings may include a primary winding and multiple secondary windings which may be connected to an outside circuit. The core halves may be used to enhance and constrain magnetic fluxes induced by either the primary or secondary windings. Each core half may include multiple core legs and auxiliary legs. The core legs may be used to facilitate the magnetic flux linked between the primary winding and the multiple secondary windings. The auxiliary legs may be used to facilitate the magnetic flux induced by the windings itself.

The planar transformers may provide adequate leakage inductance and integration of leakage inductance with low losses, particularly for applications that require higher turn ratios other than 1:1 and for applications with multiple windings and/or output ports. Additionally, the leakage inductance at each port can be adjusted independently for the planar transformers. As such, the planar transformers may be suitable for high turn ratio applications. In addition, the planar transformers may feature a symmetric geometric design and facilitate even flux distribution, by requiring two core halves and eliminating the need for complex series or parallel connections of multiple small matrix transformer units. In addition, the coupling coefficient can be tuned from approximately 1 to approximately 0 without significantly reducing the magnetizing inductance.

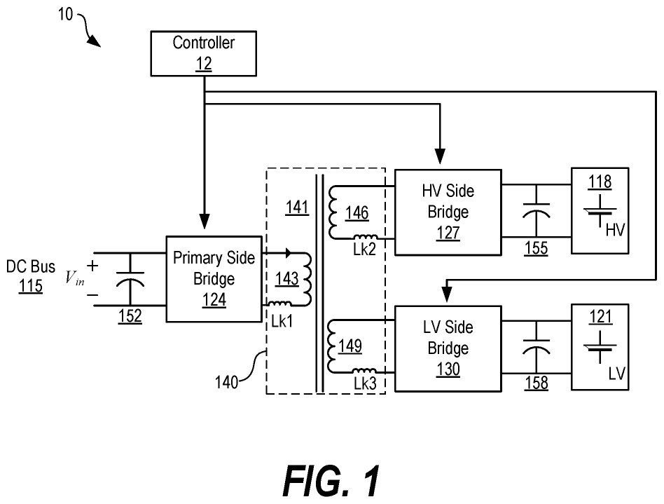

Referring now to the drawings, FIG. 1 depicts an example power converter 10 according to one or more embodiments of the present disclosure. The power converter 10 is illustrated as a representative example of a bi-directional resonant DC-to-DC power converter. In some cases, the power converter 10 can include other components that are not illustrated in FIG. 1, such as additional output converter stages, capacitors, inductors, active devices (e.g., transistors, diodes, etc.), and other components. The power converter 10 can be implemented using a combination of integrated and discrete circuit components, for example, on one or more PCBs.

The power converter 10 is additionally illustrated as a representative example of a power converter for charging a high-voltage (HV) battery and a low-voltage (LV) battery using a planar transformer. The power converter 10 may include a controller 12, a DC bus 115, a HV battery 118, a LV battery 121, a primary-side converter bridge 124 (also “primary bridge 124”), a first HV side secondary-side converter bridge 127 (also “first secondary bridge 127”) for transferring energy to the HV battery 118, a second LV side secondary-side converter bridge 130 (also “second secondary bridge 130”) for transferring energy to the LV battery 121, and a planar transformer 140 electrically coupled between the primary bridge 124 and the two secondary bridges (e.g., the first secondary bridge 127 and the second secondary bridge 130). The HV battery 118 and the LV battery 121 may be components of a battery for an EV, for example, among batteries for other purposes or applications.

The planar transformer 140 may be a three-port transformer including a core 141, a primary winding 143, a first secondary winding 146, and a second secondary winding 149. The windings 143, 146, and 149 may be planar windings implemented in a PCB in one example. The primary winding 143 may be connected to the primary bridge 124, the first secondary winding 146 may be connected to the first secondary bridge 127, and the second secondary winding 149 may be connected to the second secondary bridge 130, for transferring energy from an applied Vin via the DC bus 115 to the HV battery 118 and/or the LV battery 121. The primary bridge 124 may further be connected to a first capacitor 152, the first secondary bridge 127 may be connected to a second capacitor 155, and the second secondary bridge 130 may be connected to a third capacitor 158. The planar transformer 140 may further include a number of parasitic or leakage inductances, such as a parasitic inductor Lk1 connected to the primary winding 143, a parasitic inductor Lk2 connected to the first secondary winding 146, and a parasitic inductor Lk3 connected to the second secondary winding 149.

In one mode of operation, the planar transformer 140 may facilitate an OBC mode power flow. In another mode of operation, the planar transformer 140 may facilitate an auxiliary power module (APM) mode power flow. The power from the DC bus 115 may flow to the HV battery 118 and the LV battery 121 at the same time. The planar transformer 140 may be an integrated transformer for both OBC and APM operating modes and support both the OBC mode power flow and the APM mode power flow within a power converter system. For higher power applications, more than one planar transformer 140 may be connected in parallel while maintaining a symmetric flux distribution and adequate leakage inductance controllability.

The controller 12 may be configured to generate control signals for the primary bridge 124, the first secondary bridge 127, and the second secondary bridge 130. The control signals may direct the switching (i.e., current or power flow) operation of switching devices in the primary bridge 124, the first secondary bridge 127, and the second secondary bridge 130. Example operating frequencies for the power converter 10 can range from tens of kHz to several MHz or higher. The switching devices and operation of the primary bridge 124, the first secondary bridge 127, and the second secondary bridge 130 may be controlled by pulse width modulation (PWM) control signals generated by the controller 12, as one example. The controller 12 may also configured to direct the transfer (and direction) of power through the power converter 10 based on the control signals for the primary bridge 124, the first secondary bridge 127, and the second secondary bridge 130. Depending on the mode of operation of the power converter 10, the devices in the primary bridge 124, the first secondary bridge 127, and the second secondary bridge 130 can be directed to provide power transfer or synchronized voltage rectification.

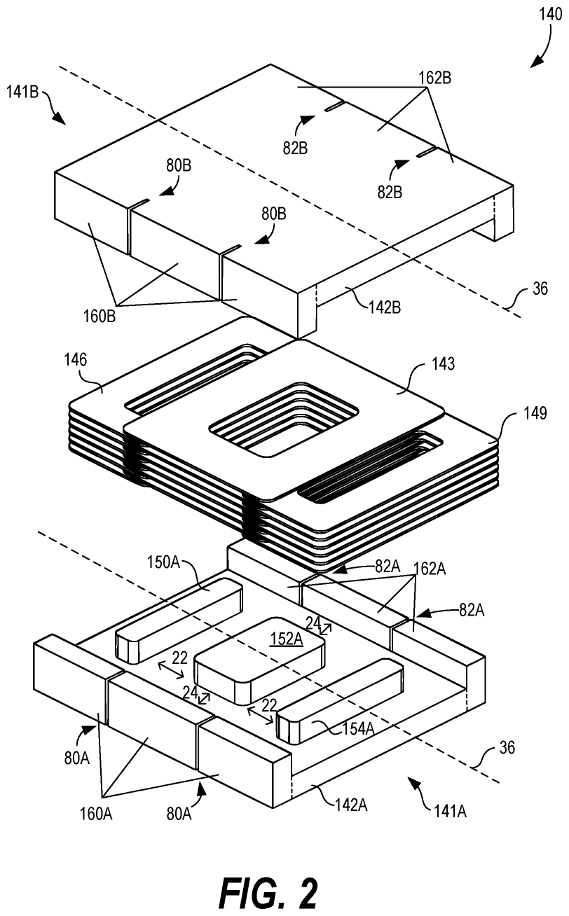

FIG. 2 depicts an exploded view of the planar transformer 140 shown in FIG. 1 according to one or more embodiments of the present disclosure. The planar transformer 140 shown in FIG. 2 is not necessarily drawn to any particular scale or size. Additionally, FIG. 2 is not exhaustively illustrated, meaning that other components that are not shown in FIG. 2 can be included or relied upon in some cases. Similarly, one or more of the components shown in FIG. 2 can be omitted in some cases. As described above with respect to FIG. 1, the planar transformer 140 may include the core 141, the primary winding 143, the first secondary winding 146, and the second secondary winding 149.

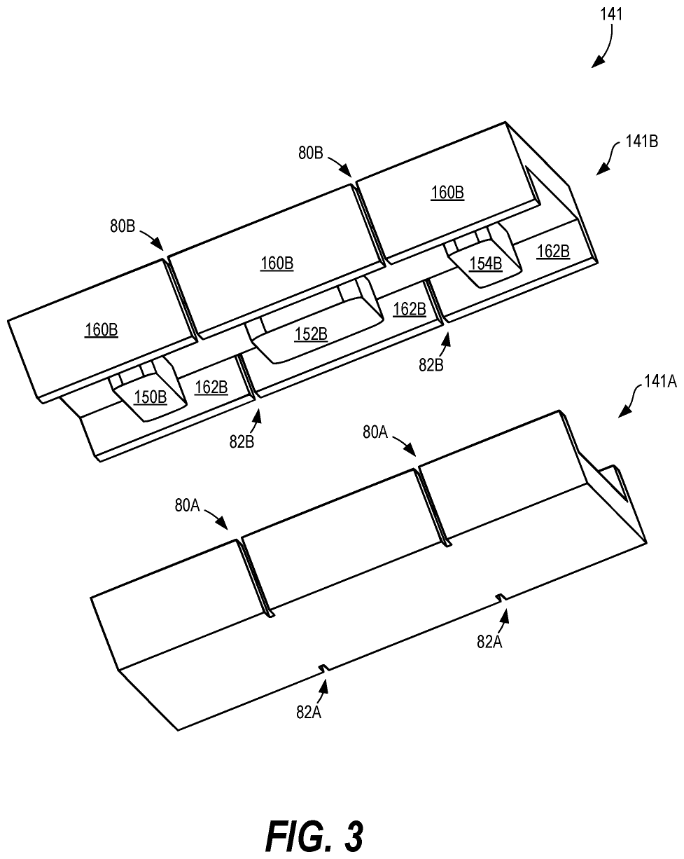

The core 141 (see also FIG. 3) can be embodied as a magnetic core and includes a first core half 141A and a second core half 141B (collectively, the “core 141”) in the example shown. The first core half 141A and the second core half 141B may be identical (i.e., mirrored parts) to each other and made of high permeability materials that can enhance and constrain the magnetic flux induced by the primary winding 143, the first secondary winding 146, and the second secondary winding 149. For example, the core 141 may include ferrite material, which may have high magnetic permeability with low electrical conductivity to prevent eddy currents induced by the primary winding 143, the first secondary winding 146, and the second secondary winding 149. The first core half 141A and the second core half 141B may be symmetrically aligned with each other and separated by one or more gaps, which will be discussed in greater detail below.

The core 141 includes multiple core legs and multiple auxiliary legs in first core half 141A and the second core half 141B in the example shown. For example, the multiple core legs may include a first side leg 150, a central core leg 152, a second side leg 154, a first auxiliary leg 160, and a second auxiliary leg 162, each of which are formed in two separable parts by the first core half 141A and the second core half 141B. The first side leg 150 may include a first side leg half 150A and a second side leg half 150B (shown in FIG. 3). The central core leg 152 may include a first central core leg half 152A and a second central core leg half 152B (shown in FIG. 3). The second side leg 154 may include a first side leg half 154A and a second side leg half 154B (shown in FIG. 3). The first auxiliary leg 160 may include a first auxiliary leg half 160A and a second auxiliary leg half 160B. The second auxiliary leg 162 may include a first auxiliary leg half 162A and a second auxiliary leg half 162B.

The first side leg 150 may be positioned to a first side of the central core leg 152. The first side leg 150 may be spaced a first distance 22 from the central core leg 152 along a centerline axis 36 extending centrally across the first side leg 150, the central core leg 152, and the second side leg 154, as shown in FIG. 2. The second side leg 154 may be positioned to a second side of the central core leg 152, the second side being opposite to the first side. The second side leg 154 may be spaced the first distance 22 from the central core leg 152 along the centerline axis 36 in a direction opposite to that of the first side leg 150. The first side leg 150 and the second side leg 154 may be symmetric (e.g., symmetrically positioned) about the central core leg 152 to create a symmetrical reluctance between central core leg 152 and the side legs 150 and 154. In some embodiments, the planar transformer 140 can be extended to form a five-port transformer. For example, an additional two side legs can be added to the planar transformer 140 so that the arrangement of the core legs of the planar transformer along the centerline axis 36 is two side legs to one side of the central core leg 152 and two side legs to an opposite side of the central core leg 152.

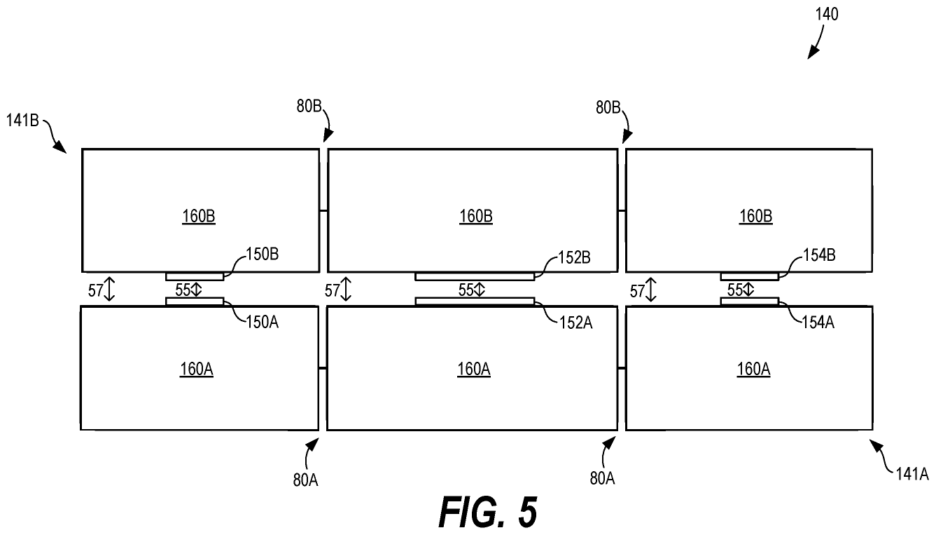

The first side leg 150, the central core leg 152, and the second side leg 154 each may be separated by a first gap 55 (shown in greater detail in FIG. 5) between the first core half 141A and the second core half 141B. For example, the first gap 55 may include individual first gaps 55 which may separate the first side leg 150 into the first side leg half 150A and the second side leg half 150B (shown in FIG. 3), separate the central core leg 152 into the first central core leg half 152A and the second central core leg half 152B (shown in FIG. 3), and separate the second side leg 154 into the first side leg half 154A and the second side leg half 154B (shown in FIG. 3).

The first side leg 150, the central core leg 152, and the second side leg 154 may be formed in the shape of a square or a rectangle with curved corners, in cross-sectional view. In some embodiments, the first side leg 150, the central core leg 152, and the second side leg 154 can be formed of a different shape such as a round or cylindrical shape, or any other suitable shape. Additionally, the curved corners can be eliminated in some cases. The first side leg 150, the central core leg 152, and the second side leg 154 may be shaped differently in other examples. The first side leg 150, the central core leg 152, and the second side leg 154 may be wider laterally (e.g., orthogonal to the centerline axis 36) than longer longitudinally (e.g., along the centerline axis 36). The first side leg 150 and the second side lag 154 may be wider laterally than the central core leg 152. The central core leg 152 may be longer longitudinally than the first side leg 150 and the second side leg 154. The first side leg 150 and the second side leg 154 may be equal in size and dimension. In addition, the section area of each of the side legs 150 and 154 may be half of that of the central core leg 152.

The first auxiliary leg 160 and the second auxiliary leg 162 may be symmetric about the central core leg 152 and the centerline axis 36. The first auxiliary leg 160 may be positioned to a third side of the central core leg 152. The second auxiliary leg 162 may be positioned to a fourth side of the central core leg 152, the fourth side being opposite of the third side. The first auxiliary leg 160 and the second auxiliary leg 162 may be spaced a second distance 24 from the central core leg 152. For example, the first auxiliary leg 160 may be spaced the second distance 24 from the central core leg 152 orthogonally away from the centerline axis 36. The second auxiliary leg 162 may be spaced the second distance 24 from the central core leg 152 orthogonally away from the centerline axis 36, in a direction opposite to that of the first auxiliary leg 160. The first auxiliary leg 160 may be separated by a second gap 57 (shown in greater detail in FIG. 5) between the first core half 141A and the second core half 141B. The second auxiliary leg 162 may also be separated by the second gap 57 between the first core half 141A and the second core half 141B. For example, the second gap may separate the first auxiliary leg 160 into the first auxiliary leg half 160A and the second auxiliary leg half 160B and separate the second auxiliary leg 162 into the first auxiliary leg half 162A and the second auxiliary leg half 162B.

The first auxiliary leg 160 and the second auxiliary leg 162 may be rectangularly shaped. In some examples, the first auxiliary leg 160 and the second auxiliary leg 162 may be shaped differently. The first auxiliary leg 160 and the second auxiliary leg 162 may be longer longitudinally (e.g., along the centerline axis 36) than wider laterally (e.g., orthogonal to the centerline axis 36). The first auxiliary leg half 160A and the first auxiliary leg half 162A may extend vertically from a base 142A of the first core half 141A. The second auxiliary leg half 160B and the second auxiliary leg half 162B may extend downwardly from a base 142B of the second core half 141B. The section area of the first auxiliary leg 160 or the second auxiliary leg 162 may vary depending on the required value of leakage inductance needed based on application of the planar transformer 140. In addition, the section area of the first auxiliary leg 160 or the second auxiliary leg 162 may be different from that of the first side leg 150, the central core leg 152, or the second side leg 154.

The first auxiliary leg 160 may include multiple individual segments separated by multiple gaps 80. For example, the first auxiliary leg 160 may include three identical segments of equal size and dimension that are formed by the first core half 141A and the second core half 141B. The three identical segments may be separated by the multiple gaps 80, where each individual gap 80 may be formed by gap 80A in the first core half 141A and a corresponding gap 80B in the second core half 141B.

The second auxiliary leg 162 may include multiple individual segments separated by multiple gaps 82. For example, the first second auxiliary leg 162 may include three identical segments of equal size and dimension that are formed by the first core half 141A and the second core half 141B. The three identical segments may be separated by the multiple gaps 82, where each individual gap 82 may be formed by gap 82A in the first core half 141A and a corresponding gap 82B in the second core half 141B. The multiple individual segments of the first auxiliary leg 160 may be equal in size and dimension to the multiple individual segments of the second auxiliary leg 162. The multiple gaps 80 and 82 may be equal in size and dimension. The multiple gaps 80 and 82 may be adjusted in depth, width (laterally, e.g., orthogonal to the centerline axis 36), and length (longitudinally, e.g., along the centerline axis 36), based on desired application of the planar transformer 140, as long as the symmetric alignment of the multiple individual segments of the first auxiliary leg 160 and the multiple individual segments of the second auxiliary leg 162 is maintained. Although two gaps 80 and two gaps 82 are illustrated in FIG. 2, more than two gaps 80 and two gaps 82 may be implemented in the core 141 in some examples, depending on the application for the planar transformer 140. In some examples, the multiple gaps 80 and 82 may adjoin to form multiple adjoining gaps, transecting the core 141 into multiple separated portions.

The primary winding 143 may be embedded in one or more layers of the PCB and wound around the central core leg 152. The first secondary winding 146 may be embedded in one or more layers of the PCB and wound around the first side leg 150. The second secondary winding 149 may be embedded in one or more layers of the PCB and wound around the second side leg 154. The primary winding 143, the first secondary winding 146, and the second secondary winding 149 may be embedded in the aforementioned layers of the PCB with copper traces to connect to other components (e.g., the primary bridge 124, the first secondary bridge 127, and the second secondary bridge 130, etc.) of the power converter 10, as shown in FIG. 1, according to one or more examples. The magnetic core may be embedded in one or more third layers of the PCB, different from that of the primary winding 143, the first secondary winding 146, and the second secondary winding 149.

The first secondary winding 146 and the second secondary winding 149 may be interleaved with the primary winding 143. For example, the first secondary winding 146 may be interleaved with a first portion of the primary winding 143, and the second secondary winding 149 may be interleaved with a second portion (e.g., different from the first portion) of the primary winding 143, as depicted in FIG. 2. Additionally, a portion of each winding turn of the first secondary winding 146 may be individually interleaved with a first portion of each winding turn of the primary winding 143, and a portion of each winding turn of the second secondary winding 149 may be individually interleaved with a second portion of each winding turn of the primary winding 143. For example, each winding turn of the first secondary winding 146 and the second secondary winding 149 is alternatingly interleaved with a winding turn of the primary winding 143. As such, the primary winding 143, the first secondary winding 146, and the second secondary winding 149 can be fully interleaved. The first secondary winding 146 and the second secondary winding 149 may be interleaved with the primary winding 143 in a symmetrically aligned fashion.

The first secondary winding 146 and the second secondary winding 149 may have the same number of winding turns to ensure a balanced flux density. The primary winding 143 may have any number of turns depending on the required turn ratio based on the application for the planar transformer 140. The first secondary winding 146 and the second secondary winding 149 may be electrically connected in series or parallel. If the first secondary winding 146 and the second secondary winding 149 are connected in parallel, the planar transformer 140 may be a half-turn transformer, which may effectively reduce the number of turns required for the primary winding 143. This may be advantageous for high turn ratio transformers. For example, if an n:1 turn ratio is required, and each of the first secondary winding 146 and the second secondary winding 149 has one turn and is in parallel connection, then the required turns of the primary winding 143 may be 0.5*n turns. The positions of the primary winding 143 and the secondary windings 146 and 149 may be interchanged as long as the symmetry about the central core leg 152 is maintained. For example, the first secondary winding 146 and the second secondary winding 149 may be combined as one unit in practice and wound around the central core leg 152, while the primary winding 143 may be wound around the first side leg 146 and the second side leg 149. Based on the symmetric core and winding structure of the planar transformer 140, the flux inside the core 141 may be naturally balanced, regardless of the turn ratio.

The first side leg 150, the central core leg 152, and the second side leg 154 may be used to enhance and constrain magnetic fluxes induced by the primary winding 143 and/or the secondary windings 146 and 149. The first side leg 150, the central core leg 152, and the second side leg 154 may be used to link the magnetic flux between the primary winding 143 and the secondary windings 146 and 149. Additionally, the first side leg 150, the central core leg 152, the second side leg 154, the first auxiliary leg 160, and the second auxiliary leg 162 may function as a lower reluctance path for magnetic flux induced by the primary winding 143 and/or the secondary windings 146 and 149 during operation.

The gaps 57, 55, 80, and 82 may be used to control the magnetizing inductance, leakage inductance, and flux distribution of the planar transformer 140. The first gap 55 may be used to control the magnetizing inductance for the magnetic flux linked between the primary winding 143 and the secondary windings 146 and 149. The second gap 57 may be used to control the leakage inductance as well as the coupling coefficient between the primary winding 143 and the secondary windings 146 and 149. The multiple gaps 80 and 82 may be used to reduce the coupling between the primary winding 143 and the secondary windings 146 and 149 in the auxiliary legs 160 and 162, thereby effectively controlling the distribution of the leakage inductance.

The multiple gaps 80 and 82 may be used to split the second gap 57 into individual second gaps 57. By way of example, if two gaps 80 and two gaps 82 are included (as shown in FIG. 2), which may divide the first auxiliary leg 160 and the second auxiliary leg 162 into three segments each, then each segment of the first auxiliary leg 160 and each segment of the second auxiliary leg 162 may be separated by an individual second gap 57. The multiple gaps 80 and 82 may help to decouple the cross-regulation between the first gap 55 and the second gap 57 but may not eliminate the cross-regulation. The magnetizing inductance may not be constant in the planar transformer 140 if the distance of the second gap 57 is adjusted.

FIG. 3 depicts an exploded view of the core 141 of the planar transformer 140, according to one or more embodiments of the present disclosure. FIG. 3 illustrates a different view of the magnetic core 141 than what is depicted in FIG. 2, to better describe the concepts included herein. For example, FIG. 3 shows a rotated view of the core 141 compared to that shown in FIG. 2, to better illustrate the second side leg half 150B, the second central core leg half 152B, the second side leg half 154B, the second auxiliary leg half 160b, and the second auxiliary leg half 162B. As discussed above, the first side leg half 150A and the second side leg half 150B form the first side leg 150, the first central core leg half 152A and the second central core leg half 152B form the central core leg 152, and the first side leg half 154A and the second side leg half 154B form the second side leg 154. Additionally, the first auxiliary leg half 160A and the second auxiliary leg half 160B form the first auxiliary leg 160, and the first auxiliary leg half 162A and the second auxiliary leg half 162B form the second auxiliary leg 162.

As discussed above, the first core half 141A and the second core half 141B may be identical to each other (e.g., mirror parts) and symmetrically aligned but separated by the one or more gaps discussed with respect to FIG. 2. For example, the first side leg half 150A may be separated from the second side leg half 150B by the first gap 55, the first central core leg half 152A may be separated from the second central core leg half 152B by the first gap 55, and the first side leg half 154A may be separated from the second side leg half 154B by the first gap 55. Additionally, the first auxiliary leg half 160A may be separated from the second auxiliary leg half 160B by the second gap 57, and the first auxiliary leg half 162A may be separated from the second auxiliary leg half 162B by the second gap 57.

The multiple gaps 80 may separate the multiple individual segments (e.g., the three identical segments) of the first auxiliary leg 160, where each individual gap 80 may be formed by gap 80A in the first core half 141A and a corresponding gap 80B in the second core half 141B. The multiple gaps 82 may separate the multiple individual segments (e.g., the three identical segments) of the second auxiliary leg 162, where each individual gap 82 may be formed by gap 82A in the first core half 141A and a corresponding gap 82B in the second core half 141B.

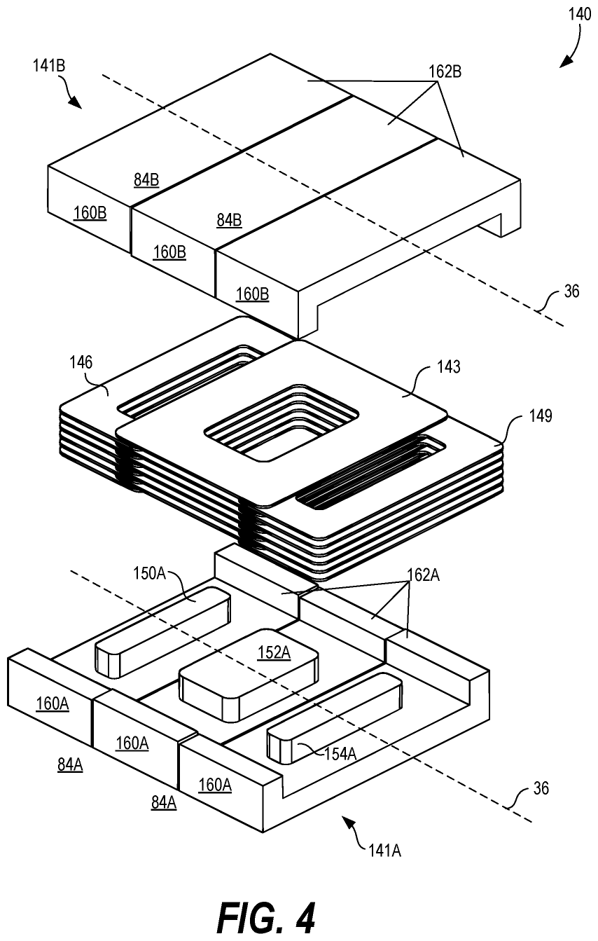

FIG. 4 depicts an exploded view of the planar transformer 140 with variations in the core 141, according to one or more embodiments of the present disclosure. Instead of the multiple gaps 80 separating the individual segments of the first auxiliary leg 160 and the multiple gaps 82 separating the individual segments of the second auxiliary leg 162, multiple adjoining gaps 84 may separate the individual segments of the first auxiliary leg 160 and the individual segments of the second auxiliary leg 162. The multiple adjoining gaps 84 may include individual adjoining gaps 84. Each individual adjoining gap 84 may be formed by gap 84A in the first core half 141A and a corresponding gap 84B in the second core half 141B. Each individual adjoining gap 84 may separate the first auxiliary leg 160 and the second auxiliary leg 162 into at least two individual segments. The multiple adjoining gaps 84 may also divide the core 141 into multiple portions. For example, as depicted in FIG. 4, the two adjoining gaps 84 may separate the core 141 into three separate portions. However, more than two adjoining gaps 84 may be implemented in the core 141 in some examples, depending on the application for the planar transformer 140. The multiple adjoining gaps 84 may be adjusted in depth, width (laterally, e.g., orthogonal to the centerline axis 36), and length (longitudinally, e.g., along the centerline axis 36), based on desired application of the planar transformer 140, as long as the symmetric alignment of the multiple individual segments of the first auxiliary leg 160 and the multiple individual segments of the second auxiliary leg 162 is maintained.

FIG. 5 depicts a front view of the planar transformer 140, according to one or more embodiments of the present disclosure. FIG. 5 is not necessarily drawn to scale or any particular size. The first auxiliary leg half 160A may be separated from the second auxiliary leg half 160B by the second gap 57. For example, each of the individual segments of the first auxiliary leg half 160A may be separated from corresponding individual segments of the second auxiliary leg half 160B by the second gap 57. The first side leg half 150A may be separated from the second side leg half 150B by the first gap 55, the first central core leg half 152A may be separated from the second central core leg half 152B by the first gap 55, and the first side leg half 154A may be separated from the second side leg half 154B by the first gap 55. Although the second gap 57 is depicted as being larger than the first gap 55, the first gap 55 may be larger than the second gap 57 or the first gap 55 may be equal to the second gap 57 in some examples.

The multiple gaps 80 may separate the multiple individual segments (e.g., the three identical segments) of the first auxiliary leg 160. Each individual gap 80 may be formed by the gap 80A in the first core half 141A and the corresponding gap 80B in the second core half 141B. The individual gaps 80A may separate the individual segments of the first auxiliary leg half 160A, and the individual gaps 80B may separate the individual segments of the second auxiliary leg half 160B.

Although the first gap 55 is depicted to be the same (e.g., in size and dimension) between the first side leg 150, the central core leg 152, and the second side leg 154, the first gap 55 can be adjusted to be different between the first side leg 150, the central core leg 152, and the second side leg 154. For example, the first gap 55 between the first side leg 150 and the first gap 55 between the second side leg 160 can be different. In another example, all three first gaps 55 shown in FIG. 5 can be different. Additionally, the second gap 57, which can separate the first side leg 160 into and the second side leg 162 (shown in FIGS. 2, 3, and 4) can also be adjusted to be different between the two side legs 160 and 162 in some embodiments. The multiple gaps 80 and 82 may be adjusted to be different from each other in some embodiments. Each individual gap of the aforementioned gaps 55, 57, 80, and 82 can be adjusted independently depending on the application of the planar transformer 140.

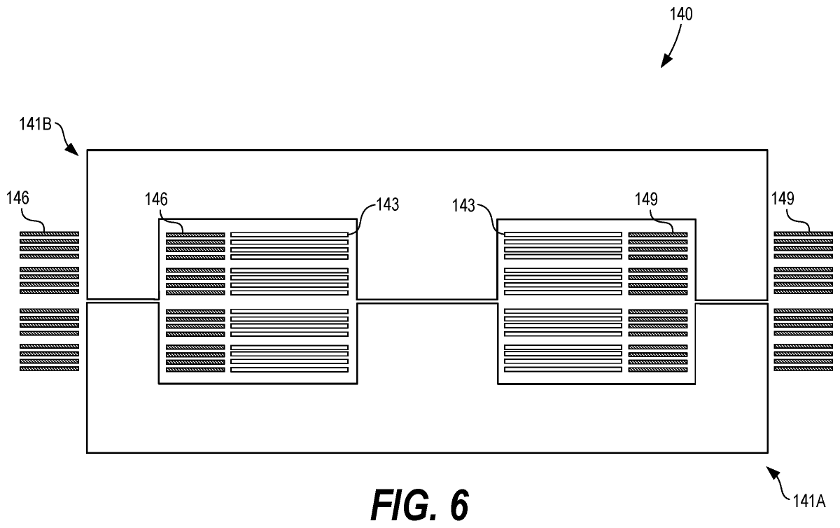

FIG. 6 depicts a front view of the planar transformer 140 with a non-interleaving winding structure, according to one or more embodiments of the present disclosure. The planar transformer 140 shown in FIG. 6 is not necessarily drawn to any particular scale or size. Additionally, FIG. 6 is not exhaustively illustrated, meaning that other components that are not shown in FIG. 6 can be included or relied upon in some cases. Similarly, one or more of the components shown in FIG. 6 can be omitted in some cases. Further, FIG. 6 is a representative example to better illustrate the non-interleaving winding structure that may be implemented in the planar transformer 140. In contrast to the partially interleaving winding structure of the primary winding 143, the first secondary winding 146, and the second secondary winding 149 depicted in FIGS. 2 and 4, the primary winding 143, the first secondary winding 146, and the second secondary winding 149 may not be interleaved at all as depicted in FIG. 6. For example, no winding turn of the primary winding 143, the first secondary winding 146, and the second secondary winding 149 are interleaved with each other.

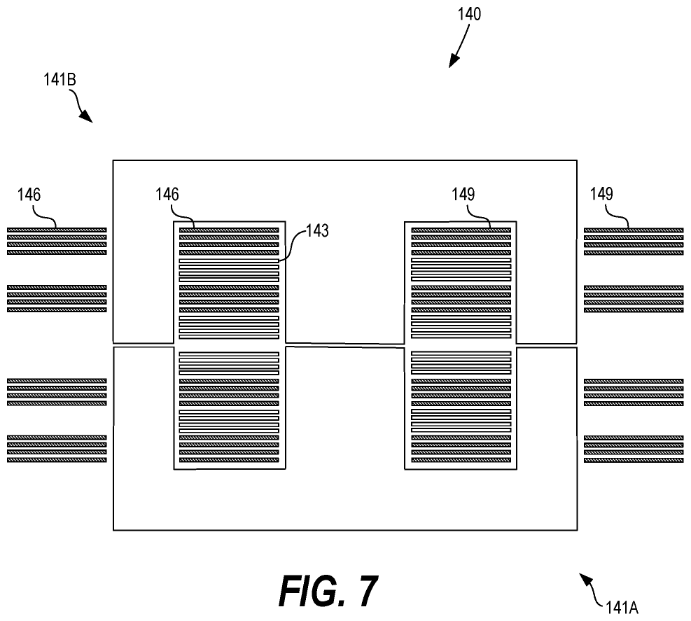

FIG. 7 depicts a front view of the planar transformer 140 with a sequentially interleaving winding structure, according to one or more embodiments of the present disclosure. The planar transformer 140 shown in FIG. 7 is not necessarily drawn to any particular scale or size. Additionally, FIG. 7 is not exhaustively illustrated, meaning that other components that are not shown in FIG. 7 can be included or relied upon in some cases. Similarly, one or more of the components shown in FIG. 7 can be omitted in some cases. Further, FIG. 7 is a representative example to better illustrate the sequentially interleaving winding structure that may be implemented in the planar transformer 140. In contrast to the partially interleaving winding structure of the primary winding 143, the first secondary winding 146, and the second secondary winding 149 depicted in FIGS. 2 and 4, the primary winding 143, the first secondary winding 146, and the second secondary winding 149 may be sequentially interleaved, as shown in FIG. 7. For example, a portion of two or more winding turns of the first secondary winding 146 is interleaved sequentially with a first portion of two or more winding turns of the primary winding 143 in the first core half 141A or the second core half 141B. Additionally, a portion of two or more winding turns of the second secondary winding 149 is interleaved sequentially with a second portion of the two or more winding turns of the primary winding 143 in the first core half 141A or the second core half 141B. However, it should be noted that the first secondary winding 146 and the second secondary winding 149 can be fully interleaved with the primary winding 143 in some embodiments. For example, each winding turn of the first secondary winding 146 and the second secondary winding 149 can be alternatingly interleaved with a winding turn of the primary winding 143.

Overall, the use of the core legs, the auxiliary legs, the alignment between the core legs and the auxiliary legs, and the gaps between the first core half and the second core half for the planar transformer 140 enables integration of large leakage inductance in power converter applications. By controlling or adjusting the gaps, the sharing of the magnetic flux between the core legs and the auxiliary legs can be managed, which can consequently control the coupling coefficient and leakage inductance. Additionally, the leakage inductance at each port of the planar transformer 140 can be adjusted independently, allowing for robust control of leakage inductance based on desired application of the planar transformer 140.

The controllers described herein, including the controller 12, can be embodied as processing circuitry, including memory, configured to control the operation of the power converters, with or without feedback. The controllers can be embodied as any suitable type of controller, such as a proportional integral derivative (PID) controller, a proportional integral (PI) controller, or a multi-pole multi-zero controller, among others, to control the operations of the power converters. The controllers can be realized using a combination of processing circuitry and referenced as a single controller. It should be appreciated, however, that the controllers can be realized using a number of controllers, control circuits, drivers, and related circuitry, operating with or without feedback.

One or more microprocessors, microcontrollers, or DSPs can execute software to perform the control aspects of the embodiments described herein, such as the control aspects performed by the controller 12. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure. Other aspects and embodiments of the integrated transformers described herein are also detailed in the paper titled “A Single Phase CLLC Resonant Converter with a Novel Matrix Integrated Transformer,” 2022 IEEE Energy Conversion Congress and Exposition (ECCE), DOI: 10.1109/ECCE50734.2022.9948196, the entire contents of which is hereby incorporated herein by reference.

Therefore, at least the following is claimed:

1. A power converter, comprising:
a primary-side converter stage and a secondary-side converter stage; and
a transformer electrically coupled between the primary-side converter stage and the secondary-side converter stage, comprising:
a magnetic core comprising:
a first core half;
a second core half;
a plurality of auxiliary legs formed by the first core half and the second core half; and
a plurality of core legs formed by the first core half and the second core half, the plurality of core legs comprising a central core leg;
a primary winding wound around the central core leg among the plurality of core legs;
a first secondary winding interleaved with the primary winding; and
a second secondary winding interleaved with the primary winding.

2. The power converter of claim 1, wherein the plurality of core legs further comprises:
a first side leg spaced a first distance from the central core leg along a centerline axis extending centrally across the central core leg; and
a second side leg spaced the first distance from the central core leg along the centerline axis in a direction opposite to that of the first side leg, wherein:
the first side leg and the second side leg are symmetric about the central core leg.

3. The power converter of claim 2, wherein:
the first secondary winding is wound around the first side leg; and
the second secondary winding is wound around the second side leg.

4. The power converter of claim 2, wherein:
the first side leg is separated by a first gap between the first core half and the second core half;
the second side leg is separated by the first gap between the first core half and the second core half; and
the central core leg is separated by the first gap between the first core half and the second core half.

5. The power converter of claim 1, wherein:
a portion of each winding turn of the first secondary winding is individually interleaved with a first portion of each winding turn of the primary winding; and
a portion of each winding turn of the second secondary winding is individually interleaved with a second portion of each winding turn of the primary winding.

6. The power converter of claim 1, wherein:
a portion of two or more winding turns of the first secondary winding is interleaved sequentially with a first portion of two or more winding turns of the primary winding in the first core half or the second core half; and
a portion of two or more winding turns of the second secondary winding is interleaved sequentially with a second portion of the two or more winding turns of the primary winding in the first core half or the second core half.

7. The power converter of claim 1, wherein the plurality of auxiliary legs comprises:
a first auxiliary leg spaced a second distance from the central core leg orthogonally away from a centerline axis, the centerline axis extending centrally across the central core leg; and
a second auxiliary leg spaced the second distance from the central core leg orthogonally away from the centerline axis, in a direction opposite to that of the first auxiliary leg, wherein:
the first auxiliary leg and the second auxiliary leg are symmetric about the central core leg.

8. The power converter of claim 7, wherein:
the first auxiliary leg is separated by a second gap between the first core half and the second core half; and
the second auxiliary leg is separated by the second gap between the first core half and the second core half.

9. The power converter of claim 8, wherein:
the first auxiliary leg includes a first plurality of individual segments, the first plurality of individual segments being individually separated by a first plurality of gaps in the first core half and the second core half; and
the second auxiliary leg includes a second plurality of individual segments, the second plurality of individual segments being individually separated by a second plurality of gaps in the first core half and the second core half, the first plurality of gaps and the second plurality of gaps being equal.

10. The power converter of claim 8, wherein:
the first auxiliary leg includes a first plurality of individual segments, the first plurality of individual segments being individually separated by a plurality of gaps in the first core half and the second core half; and
the second auxiliary leg includes a second plurality of individual segments, the second plurality of individual segments being individually separated by the plurality of gaps.

11. The power converter of claim 10, wherein the plurality of gaps in the first core half and the second core half separate the magnetic core into a plurality of individual portions.

12. The power converter of claim 1, wherein:
the transformer is a planar transformer implemented in a printed circuit board (PCB); and
the primary winding, the first secondary winding, and the second secondary winding are planar windings implemented in one or more layers of the PCB.

13. The power converter of claim 1, wherein the transformer is a three-port transformer configured to enable both an onboard charger (OBC) mode power flow operation and an auxiliary power module (APM) mode power flow operation for the power converter.

14. A planar transformer, comprising:
a magnetic core, comprising:
a first core half;
a second core half;
a plurality of auxiliary legs formed by the first core half and the second core half; and
a plurality of core legs formed by the first core half and the second core half, the plurality of core legs comprising a central core leg;
a primary winding wound around the central core leg among the plurality of core legs;
a first secondary winding interleaved with the primary winding; and
a second secondary winding interleaved with the primary winding.

15. The planar transformer of claim 14, wherein:
the planar transformer is implemented in a printed circuit board (PCB); and
the primary winding, the first secondary winding, and the second secondary winding are planar windings implemented in one or more layers of the PCB.

16. The planar transformer of claim 14, wherein the plurality of core legs further comprises:
a first side leg spaced a first distance from the central core leg along a centerline axis extending centrally across the central core leg; and
a second side leg spaced the first distance from the central core leg along the centerline axis in a direction opposite to that of the first side leg, wherein:
the first side leg and the second side leg are symmetric about the central core leg.

17. The planar transformer of claim 16, wherein:
the first side leg is separated by a first gap between the first core half and the second core half;
the second side leg is separated by the first gap between the first core half and the second core half; and
the central core leg is separated by the first gap between the first core half and the second core half.

18. The planar transformer of claim 14, wherein the plurality of auxiliary legs comprises:
a first auxiliary leg spaced a second distance from the central core leg orthogonally away from a centerline axis, the centerline axis extending centrally across the central core leg; and
a second auxiliary leg spaced the second distance from the central core leg orthogonally away from the centerline axis, in a direction opposite to that of the first auxiliary leg, wherein:
the first auxiliary leg and the second auxiliary leg are symmetric about the central core leg.

19. The planar transformer of claim 18, wherein:
the first auxiliary leg is separated by a second gap between the first core half and the second core half; and
the second auxiliary leg is separated by the second gap between the first core half and the second core half.

20. The planar transformer of claim 19, wherein:
the first auxiliary leg includes a first plurality of individual segments, the first plurality of individual segments being individually separated by a plurality of gaps in the first core half and the second core half; and
the second auxiliary leg includes a second plurality of individual segments, the second plurality of individual segments being individually separated by the plurality of gaps.
